(19) United States
(12) Patent Application Publication
(10) Pub. No.: US 2010/0025999 A1
(43) Pub. Date: Feb. 4, 2010

(54) Ocean wave electricity generation

(76) Inventors: Chong Hun Kim, Fountain Valley, CA (US); Jennifer Jiuhee Kim, Los Angeles, CA (US); David Kernhoe Kim, Los Angeles, CA (US)

Correspondence Address: CHONG HUN KIM, 16807 WOODRIDGE CIR., FOUNTAIN VALLEY, CA, 92708, US

(21) Appl. No.: 12/221,407

(22) Filed: Aug. 4, 2008

(51) Int. Cl. F03B 13/14

(52) U.S. Cl. 290/53

(57) ABSTRACT

This invention relates to electricity generation from the ocean wave by use of mechanical systems, submerged or on surface, collecting energy day and night regardless weather condition in a way similar to the way of collecting energy by use of solar panels or wind mills, without contacting the salty ocean water. The principal mechanism invented is as follows. Swinging of a heavy mass due to the ocean wave generates torque that sways gear wheel in clockwise or counterclockwise, thus transmitting the torque energy to two gear wheels that separate clockwise swing and counterclockwise swing via two sets of spring-piston clutching system and by use of gear chain, either converting clockwise swing to counterclockwise swing or vise versa such that the back and forth motion of the mass transforms into unidirectional rotation that rotates the rotor of electricity generator.

### CROSS-REFERENCE TO RELATED APPLICATIONS

U.S. Patent Documents

| | | | |
|---|---|---|---|
| 4,418,286 | November 1983 | Scott | 290/42 |
| 4,603,551 | August 1986 | Wood | 60/496 |
| 4,851,704 | July 1989 | Rubi | 290/53 |
| 5,929,531 | July 1999 | Lagno | 290/53 |
| 6,269,636 | September 2001 | Hatzilakos | 60/398 |
| 6,574,957 | June 2003 | Brumfield | 60/398 |
| 6,756,695 | June 2004 | Hibbs | 290/42 |
| 6,814,633 | November 2004 | Huang | 440/9 |
| 7,012,340 | March 2006 | Yi | 290/42 |
| 7,352,078 | April 2008 | Gehring | 290/54 |
| 7,365,445 | April 2008 | Burcik | 290/53 |

### BACKGROUND OF THE INVENTION

1. Field of the Invention

This invention relates to electricity generation from the ocean wave by use of mechanical systems, submerged or on surface, collecting energy day and night regardless weather condition in a way similar to the way of collecting energy by use of solar panels or wind mills, without contacting the salty ocean water.

2. Description of the Related Art

Realizing the fact that the ocean tide (wave) carries tremendous energy as it moves, many types of energy harnessing scheme or devices have been explored and developed. But none of them seem to be practical in terms of manufacturing and installation. All of the following ten inventions require contact with the sea water and complex construction processes. Burcik (U.S. Pat. No. 7,365,448, year 2007) makes use of bore hole. Yi (U.S. Pat. No. 7,012,340, year 2006), Hibbs (U.S. Pat. No. 6,756,695, year2004), Hatzlakos (U.S. Pat. No. 6,269,636, year 2001), Rubi (U.S. Pat. No. 4,851,704, year 1989), and Wood (U.S. Pat. No. 4,603,551, year 1986) take advantage of buoyancy of sea wave. Gehring (U.S. Pat. No. 7,352,078, year 2008) proposes a set of blades shrouded to generate motion. Brumfield (U.S. Pat. No. 6,574,957, year 2003) generates pressure by using the ocean wave. Lagno (U.S. Pat. No. 5,929,531, year 1999) stores energy in a torsional spring from the ocean wave. Finally Scott (U.S. Pat. No. 4,418,281, year 1983) proposes counterbalance walking beam that moves to collect energy. Abstracts of these inventions follow.

U.S. Pat. No. 7,365,448 to Burcik (2007) proposes a wave motion generator having a bore hole at a coastline of an ocean. The bore hole lower end communicates with the ocean underwater while the upper end is above water level, allowing wave motion within the bore hole. A float disposed within the bore hole may travel along the borehole between at least two positions. A linkage attached to the float converts the motion of the float to rotary motion of a generator shaft so as to induce electric current in the generator. The linkage may be pneumatic, in which the float motion induces pressurized air to drive a turbine, or it may be a chain drive, a shaft drive, etc.

U.S. Pat. No. 7,352,078 to Gehring (2008) proposes an offshore power generator that includes an offshore platform. Current, wind, wave and other renewable energy generators are mounted to the offshore platform. Each current generator has a shroud enclosing a set of blades. A hub member is located within the shroud and extends in an upstream direction from the blades. The flow area between the interior of the shroud and the hub member converges from the shroud inlet to the blades.

U.S. Pat. No. 7,012,340 to Yi (2006) proposes an ocean wave energy conversion apparatus that includes a float adapted to ride on the surface of the ocean in reciprocal vertical motion in response to ocean wave front action and a lever adapted to ride on the surface of the ocean. The lever has one end coupled to the float. A fulcrum pivotally supports the lever. A magnet is coupled to the other end of the lever. Parallel stator cores having electric coils wound thereon together with the magnet form a magnetic circuit. Springs are adjacent the magnet and interconnected to the lever and the magnet. A barrier is disposed between adjacent stator cores. The upward motion of the float caused by impact of waves will move the magnet downward by the lever and compresses the springs. Downward motion of the float will move the magnet upward by the lever and expand the springs. Repeated movement of the magnet will induce a voltage in the electric coils.

U.S. Pat. No. 6,756,695 to Hibbs, et al. (2004) proposes a method of and apparatus for generating electricity from ocean waves by utilizing a float with excessive buoyancy. The basic arrangement and principle utilizes a float with excess buoyancy which exerts a primarily upward buoyant force on the float along a direction perpendicular to the isobaric surfaces of the ocean waves which changes as the ocean waves propagating through the water body. A holding device is used to hold the float under the ocean surface, which exerts a primarily downward holding force on the float while allowing the float to move back and forth in a substantially horizontal direction as a result of a substantially horizontal force which is a combination of the holding force and the buoyant force. A turbine is attached to the float or the holding device for generating electricity as the float moves back and forth in the liquid body.

U.S. Pat. No. 6,574,957 to Brumfield (2003) propose a system for using tidal or wave action to compress air at a high pressure and produce electricity. The system includes a piston contained in a chamber including an air intake port. The chamber is connected to an air storage tank through a valve. A moveable power transfer shaft contained in a sleeve guide has a float disposed on ocean waves providing motion to the shaft. A lever arm is contacted by the power transfer shaft at one end and is connected to the piston at another end. As the power transfer shaft is upwardly displaced by the float, so is the lever arm at one end causing the piston to compress air within the chamber at another end. When a dual piston embodiment is employed, air is compressed upon upward and downward movement of the power transfer shaft. In an alternative embodiment, a gear mechanism is employed to transfer the linear movement of the power transfer shaft to the pistons. In both the lever and the gear embodiments, the air is compressed and stored at a high pressure in a storage tank. The compressed air is transferred from the storage tank and to a turbine or other mechanism where electricity is generated.

U.S. Pat. No. 6,269,636 to Hatzlakos (2001) proposes the following. The waves of the sea, move a float 1 vertically upwards and downwards. This motion is transferred and converted to rotational energy along a horizontal shaft 8. The float 1, an empty plastic sphere filled with ballast 11, floats half-immerged and moves the vertical metal beam 2, the length of which can be increased or decreased in order to deal with the tidal changes. The beam 2, attached with knuckle joints to the ends of a biparallel metal lever 3, transfers the vertical motion to the other end, to the saw 5, with the attached and vertically moving due to the biparallel lever chains 6, which rotate two gears, each chain to the diametrically opposite side of each gear, so that in every up/down movement, one gear is producing action while the other moves freely 20. The gears rotate the horizontal shaft 8 which is fitted on them and the horizontal shaft gives motion to the generator. Thus, every movement of the float 1, whether upwards or downwards, small or big, rotates the shaft 8. This device, from float to generator, forms one unit. Many units placed in parallel side by side, activate a common shaft 8, which activates the generator. The floats are restricted inside metal cages 21 or inside recesses built in piers 24 and act as the cylinders of a multi-cylinder engine, independently one from the other, but cumulatively with enhancing power, on the same shaft. Many units form a group of units.

U.S. Pat. No. 5,929,531 to Lagno (1999) proposes the following. A lunar tide powered hydroelectric plant of variable size and power generation capacity for basing on land or in tide waters. The basic collection of mechanical power is done by torsion spring bank units positioned on a concrete barge. The land-based plant obtains oscillatory motion from a notched frame. The tide water based plant obtains oscillating motion from notched piling. An individual torsion spring bank unit can comprise columns of horizontally aligned torsion springs based on a row of torsion springs of a bottom control cell. The tidal and wave motion is transferred to the torsion spring banks. A computer system manages the release of each torsion spring column to a drive shaft of a generator to produce electrical power. The computer system also permits the conversion of kinetic energy by reversing the gearing system for the upward motion of the floating barge so as to obtain a constant input of kinetic energy to the generator.

U.S. Pat. No. 4,851,704 to Rubi (1989) proposes the following. This invention discloses a wave action electricity generation system that includes a floating platform that supports the system components on the surface of a body of water, an anchor means for controlling movement of the platform to a desired water surface area of the body of water, a kinetic energy converter that converts wave motion energy into mechanical energy and an electricity generator that converts the mechanical power transfer strokes into electrical energy. The kinetic energy converter includes a cylinder containing a fluid, such as a lubricant, in opposed cylinder chamber portions, a first heavily weighted piston that is slidably and freely disposed within the body of the cylinder. The heavily weighted piston is slidably responsive to the wave motion energy of the body of water and is used to compress the fluid to produce respective compression power strokes in each of the cylinder chamber portions. The energy in the compression stroke is received by a second and third pistons located in the cylinder chamber portions that further produce power transfer strokes through the ends of the cylinder. The power transfer strokes associated with the first and second pistons are further converted by a geared transmission to rotary motion that turns a flywheel coupled to an electricity generator. The electrical energy produced is then distributed to a remote power station via a power transmission line.

U.S. Pat. No. 4,603,551 to Wood (1986) proposes the following. A relatively lightweight ‘motivator buoy’, constrained by guides attached to a ballasted “floating platform” of contrasting and static buoyancy characteristics, reciprocates vertically by wave action, lifting water via a piston and cylinder through automatic non-return valves into a pressurized storage compartment incorporating a compressible medium such as an airspace, then turning a water turbine and electricity generator, or alternatively providing a hydraulic power source for other uses. Modules so constructed may be linked by an above-water framework to form continuous arrays.

U.S. Pat. No. 4,418,281 to Scott (1983) proposes the following. This invention is an electric generator system which is wave and/or tidal driven and includes energy storage means to allow a constant electrical output to be realized. The above is accomplished through a Counterbalanced walking beam which is wave driven. This beam is connected to one way ratchet drives and an interconnected spring system of varying torque capacities. A governor is connected to the spring system thereby allowing the generator to be driven at a constant speed.

### BRIEF SUMMARY OF THE INVENTION

FIG. 1 shows a basic configuration of an electricity generation cell which collects energy from the ocean (tide) wave. The electricity generation cells are fixed on cell boxes (26 in FIG. 10) oriented to attain maximum energy. The cell boxes float under the sea water or on the surface in the ocean. As the ocean wave induces swing motion of the floating cell boxes, the heavy mass (1) in FIG. 1 swings back and forth. The swing motion of the mass (1) generates torque that causes the gear wheel (10) to swing in clockwise or counterclockwise. The lever length (2) can be as long as it is allowed to increase the torque force. Now if the gear wheel (10) swings in clockwise (FIG. 2 and FIG. 4), then the gear wheel (4) and the gear wheel (19) swing in counterclockwise. During the swing, the spring-piston clutching mechanism (5) disengages the gear wheel (4) from the wheel (8) while the clutching mechanism (20) engages the gear wheel (19) and the wheel (21). (The engagement and disengagement mechanisms are shown in FIG. 4 and FIG. 7.) Thus, the wheel (21) swings in counterclockwise while the wheel (8), in clockwise. It will be shown later that the clockwise swing of the wheel (8) is due to the counterclockwise swing of the wheel (21). The counterclockwise swing of the wheel (21) causes the clockwise swing of the gear wheel (12).

Now if the gear wheel (10) swings in counterclockwise (FIG. 3 and FIG. 7), then the gear wheel (4) and the gear wheel (19) swing in clockwise. During the swing, the spring-piston clutching mechanism (5) engages the gear wheel (4) and the wheel (8) while the spring-piston clutching mechanism (20) disengages the gear wheel (19) from the wheel (21). Thus, the wheel (8) swings in clockwise while the wheel (21), in counterclockwise. It will be shown later that the counterclockwise swing of the wheel (21) is due to the clockwise swing of the wheel (8). The clockwise swing of the wheel (8) causes the counterclockwise swing of the gear wheel (18) and the gear wheel (17), which in turn causes the clockwise swing of the gear wheel (12), which is the same swinging direction as was in the previous paragraph.

Thus, the back and force swing motion of the mass (1) transforms into uni-directional rotation, that is clockwise rotation in this configuration, which rotates the rotor of electricity generator and generates electricity. The spring-piston clutching mechanisms (5, 20) are designed such that the wheels (8, 21, 18, 11, and 17) act like flywheels and store the torque energy.

### BRIEF DESCRIPTION OF DRAWINGS

FIG. 1 shows a basic structural configuration of electricity generation cell embodiment of the invention.

FIG. 2 shows a basic structural configuration of electricity generation cell embodiment of the invention when the mass (1) swings forward.

FIG. 3 shows a basic structural configuration of electricity generation cell embodiment of the invention when the mass (1) swings backward.

FIG. 4 shows how the spring-piston clutch systems work when the gear wheel (10) swings in clockwise.

FIG. 5 shows disengagement [between the gear wheel (4) and the wheel (8)] process of one spring-piston clutch unit from the clutch assembly bank.

FIG. 6 shows engagement process [between the gear wheel (19) and the wheel (21)] of one spring-piston clutch unit from the clutch assembly bank.

FIG. 7 shows how the spring-piston clutch systems work when the gear wheel (10) swings in counterclockwise.

FIG. 8 shows disengagement process [between the gear wheel (19) and the wheel (21)] of one spring-piston clutch unit from the clutch assembly bank.

FIG. 9 shows engagement process [between the gear wheel (4) and the wheel (8)] of one spring-piston clutch unit from the clutch assembly bank.

FIG. 10 shows a sketch of the Ocean Wave Electricity Generation assembly infrastructure.

FIG. 11 shows one of many possible orientations of the electricity generation cell

### DETAILED DESCRIPTION OF THE INVENTION

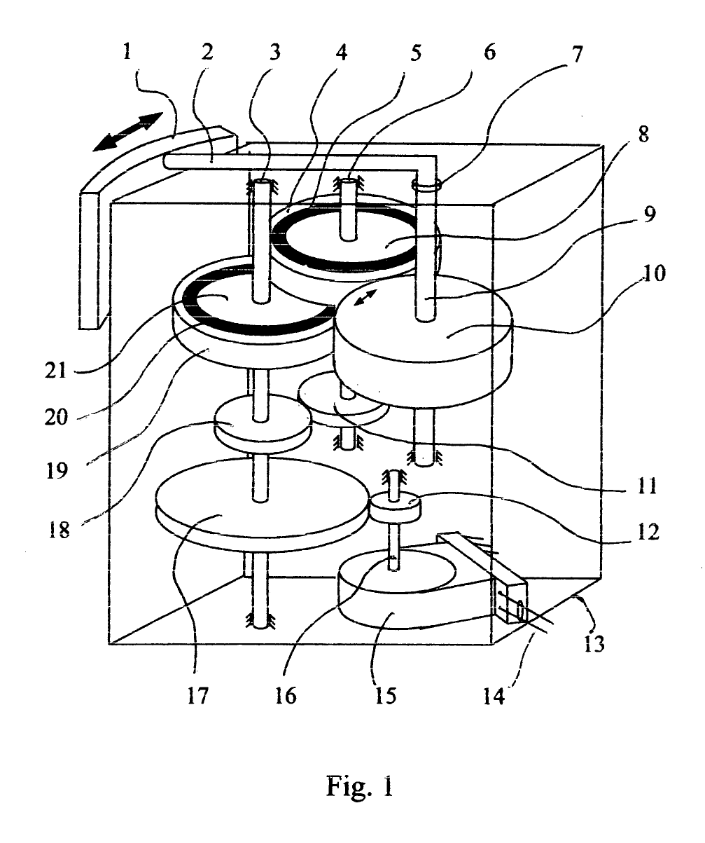

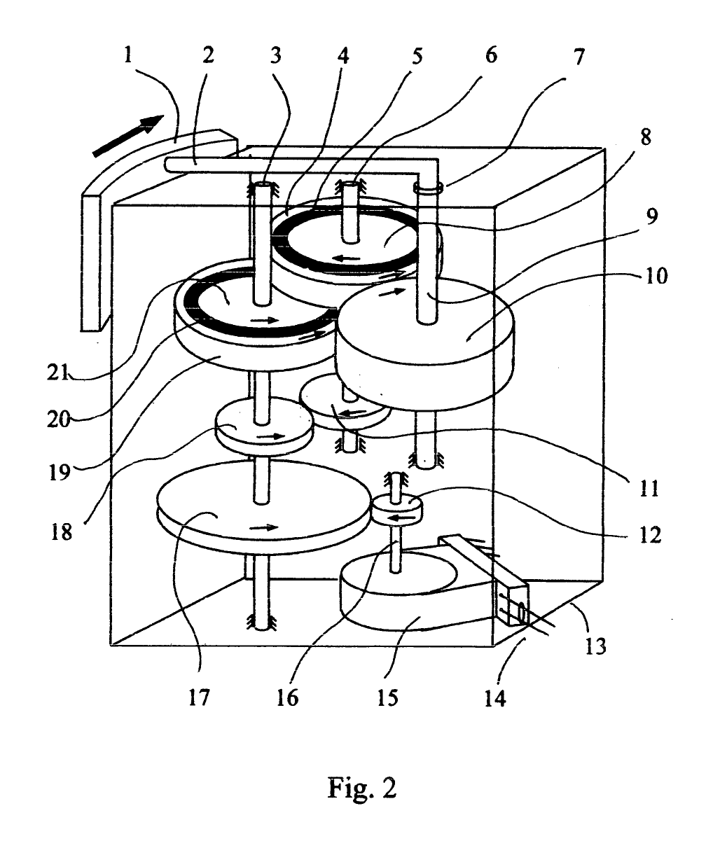

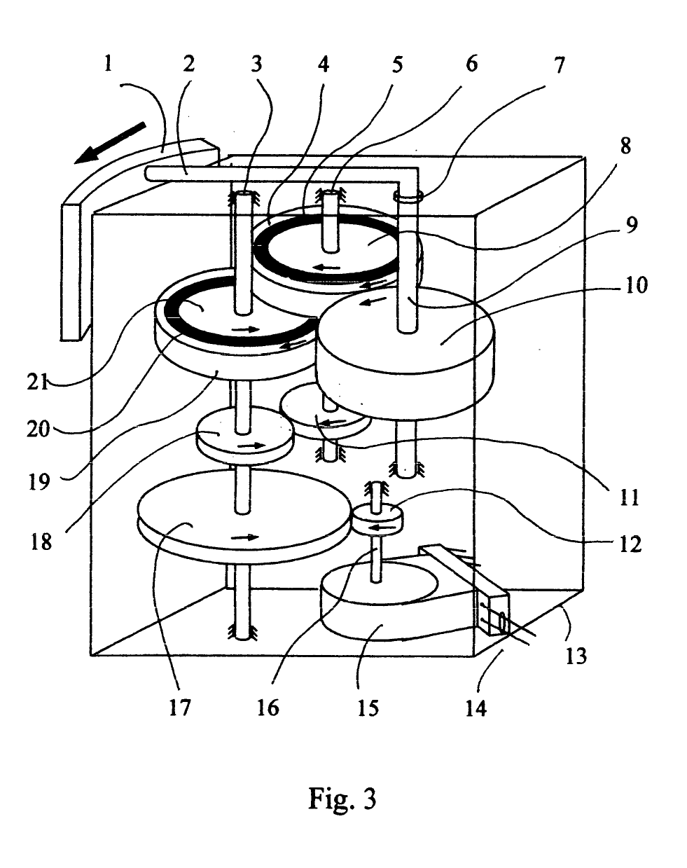

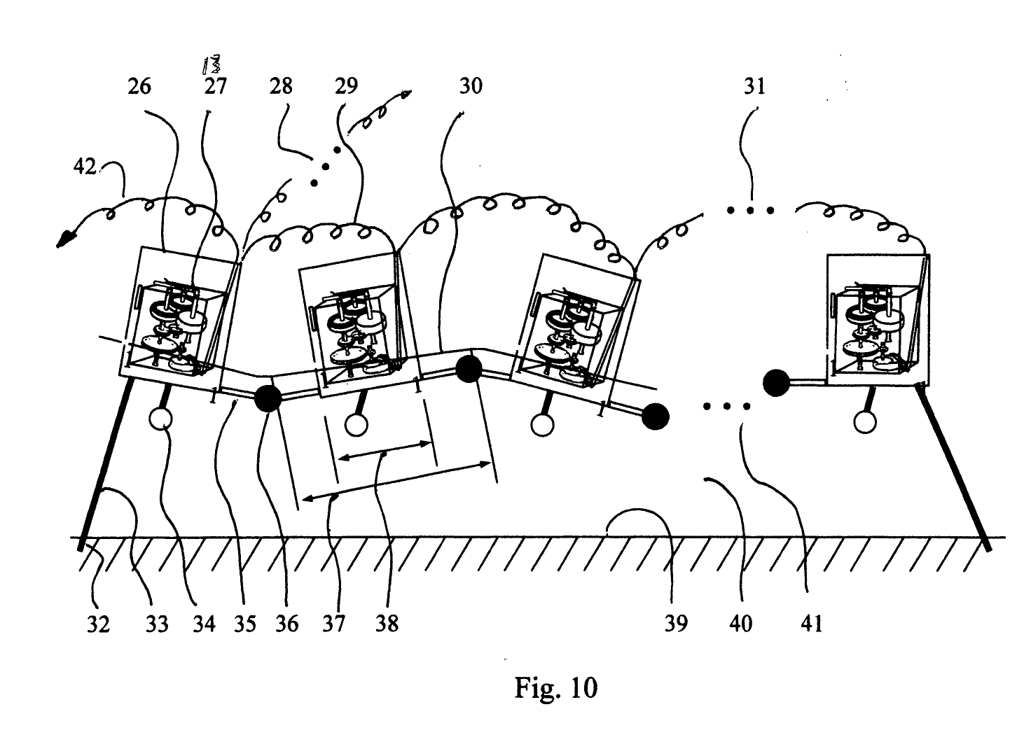

FIG. 1 is a perspective view of a preferred embodiment of an electricity generation cell, showing how to collect energy from the ocean (tide) wave. The mass (1) moves back and forth as the cell box (27 in FIG. 10) swings on the ocean wave or tide. The lever (2) is connected to the shaft (9) and as the mass (1) moves back and forth, it swings the gear wheel (10) in clockwise or counterclockwise. As the gearwheel (10) swings in clockwise or counterclockwise, the gear wheel (4) and the gear wheel (19) swing at the same time in counterclockwise or clockwise. FIG. 2 shows the case when the gear wheel (10) swings in clockwise and FIG. 3, in counterclockwise.

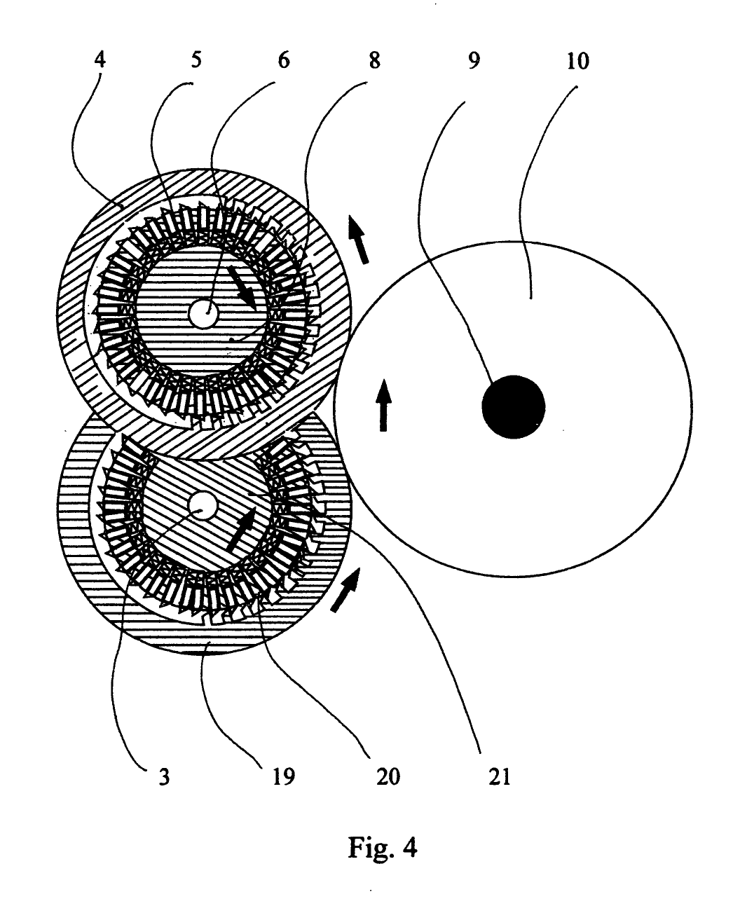

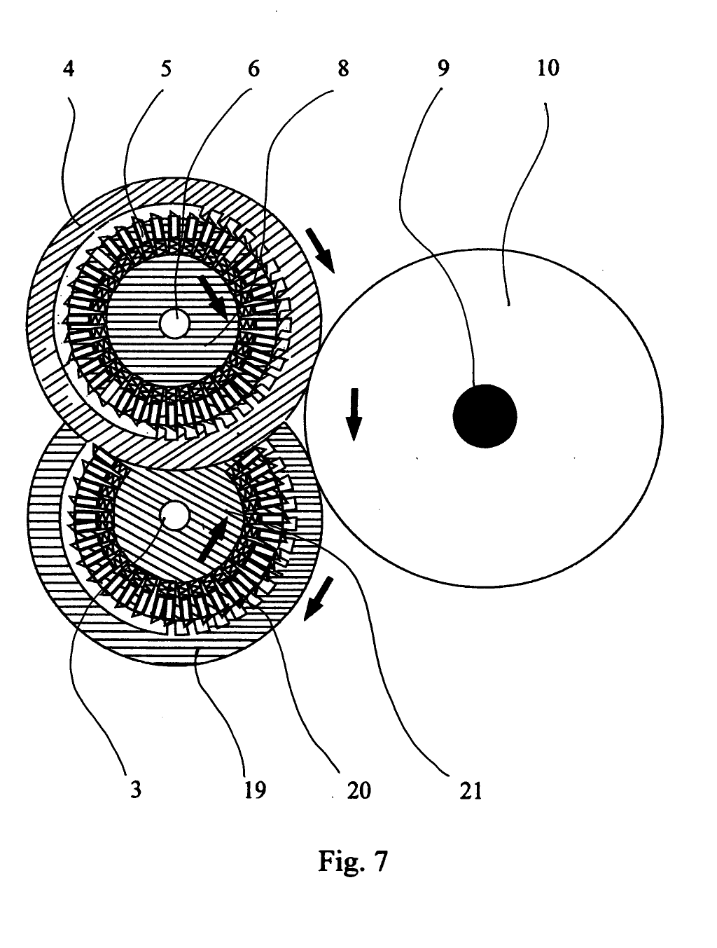

In FIG. 2, the gear wheel (10) swings in clockwise. The clockwise swing of the gear wheel (10) sways the gear wheel (4) and the gear wheel (19) in counterclockwise at the same time. Here, a mechanism is designed such that the gear wheel (19) transmits its torque to the wheel (21) via bank of spring-piston clutches (20). The detail explaining how the spring-piston clutch works is shown in FIG. 4 and FIG. 7. Thus, the counterclockwise swing of the gear wheel (19) sways the wheel (21) in the same direction. Since the wheel (21), the gear wheel (18), and the gear wheel (17) are all fixed on the shaft (3), they swing in the same direction, that is, in counterclockwise. The swing of the gear wheel (18) sways the gear wheel (11). Since the gear wheel (11) and the wheel (8) are fixed on the shaft (6), they swing in the same direction, that is, in clockwise. Notice that the gear wheel (4) and the wheel (8) swing in the opposite direction, disengaging them. The counterclockwise swing of the gear wheel (17) sways the gear wheel (12) in clockwise, which is the direction that the rotor in the electricity generator rotates. By having a large gear ratio between the gear wheel (17) and the gear wheel (12), high rate of rotation of the gear wheel (12) can be achieved.

In FIG. 3, the gear wheel (10) swings in counterclockwise. The counterclockwise swing of the gear wheel (10) sways the gear wheel (4) and the gear wheel (19) in clockwise at the same time. Via the bank of spring-piston clutching mechanism (5), the gear wheel (4) transmits its torque energy to the wheel (8). Thus, the clockwise swing of the gear wheel (4) sways the wheel (8) in the same direction. Since the wheel (8) and the gear wheel (11) are all fixed on the shaft (6), they swing in the same direction, that is, in clockwise. The swing of the gear wheel (11) sways the gear wheel (18) in counterclockwise. Since the wheel (21), the gear wheel (18), and the gear wheel (17) are all fixed on the shaft (3), they swing in the same direction, that is, in counterclockwise. Notice that the wheel (21) and the gear wheel (19) swing in opposite direction, disengaging them. The counterclockwise swing of the gear wheel (17) sways the gear wheel (12) in clockwise, which is the consistent direction attained when the mass (1) swings forward in FIG. 2.

Thus, as the mass swings back and forth (or upward and downward), the gear wheel (12) consistently rotates in one direction, that is, either clockwise or counterclockwise direction depending on how the spring-piston clutching system is set up.

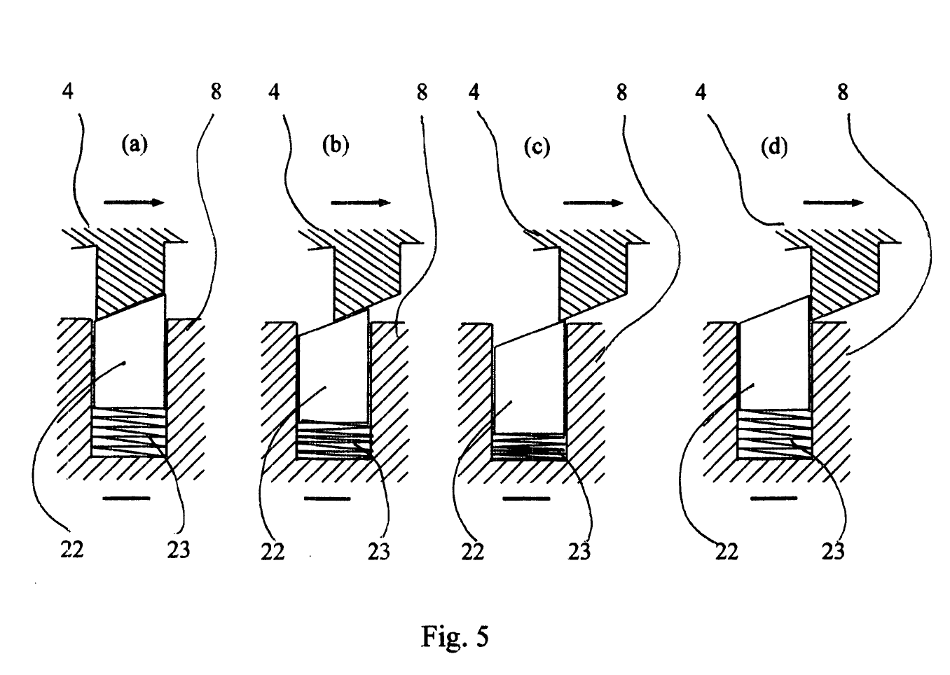

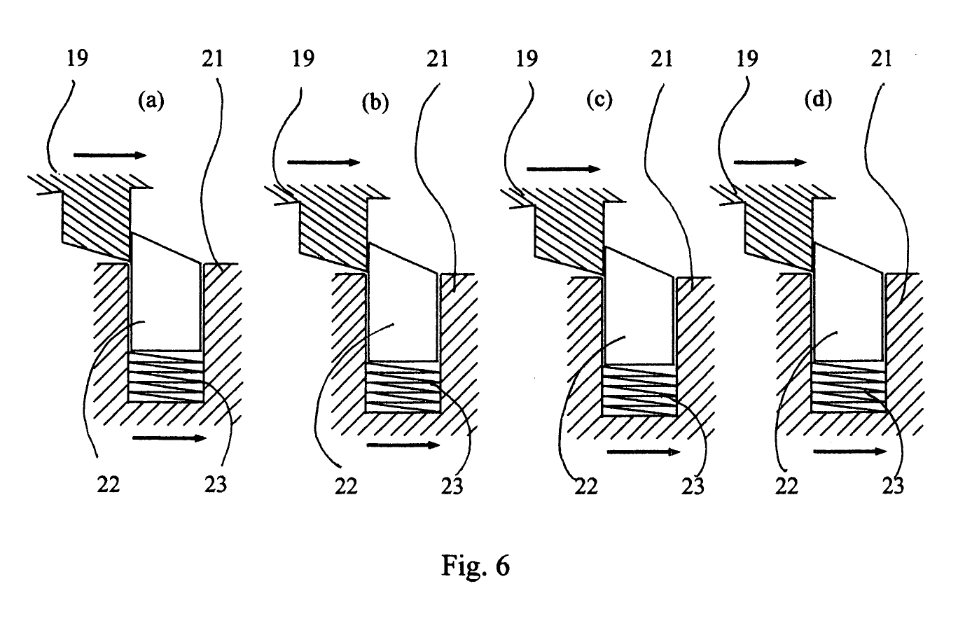

FIG. 4 explains how the torque gets transmitted from the gear wheel (10) to the wheel (21) and how the disengagement takes place between the gear wheel (10) and the wheel (8). Arrows in the figure show the directions of the swing. The spring-piston clutch mechanism (5) is explained by expanding one spring-piston unit of the part (5). The expanded configuration is shown in FIG. 5 and FIG. 6. In FIG. 5, the disengaging process is shown. FIG. 5(a) is the beginning of contact between the gear wheel (4) and the piston (22). As the gear wheel (4) moves to the right (which is the case in FIG. 4), the piston (22) moves downward and presses down the spring (23) [FIG. 5(b)]. FIG. 5(c) shows the end of the disengagement process. It is shown here that the spring (23) is pressed all the way down and the piston (22) is also moved all the way down. The next moment the gear wheel (4) passes the piston (22) tip and the piston (22) comes back to the original position and so is the spring (23). The gear wheel (4) moves to the right, but the wheel (8) does not follow the gear wheel (4).

FIG. 6 shows that as the gear wheel (19) moves to the right, the wheel (21) follows the gear wheel (19) because the piston (22) does not get pressed down and wheel (19) pushes the piston (22) and the wheel (21) at the same time to the right. Thus, the torque force gets transmitted from the gear wheel (10) to the wheel (21). In this set up, the wheel (21) swings in counterclockwise.

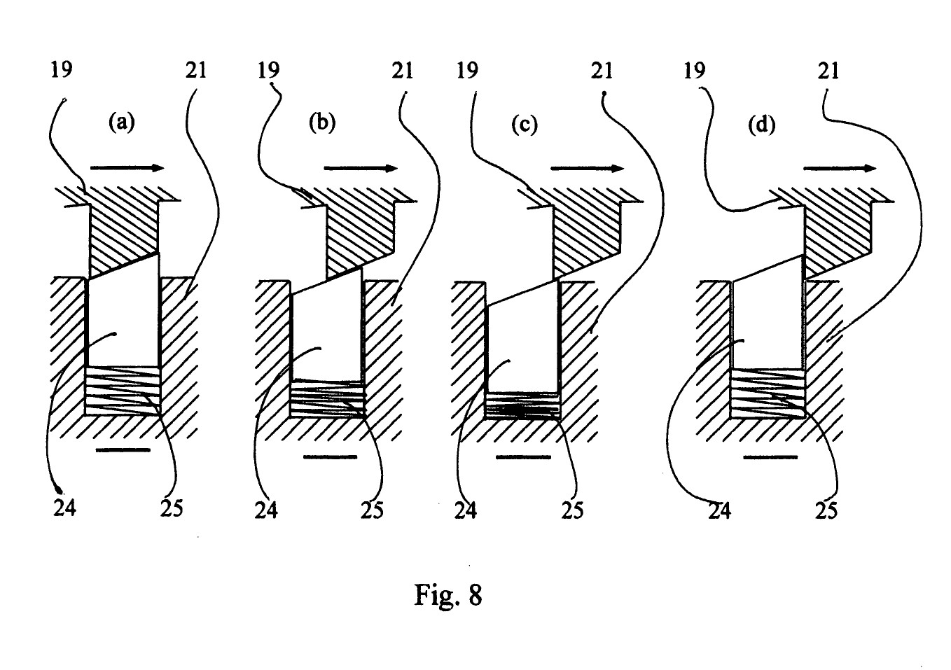

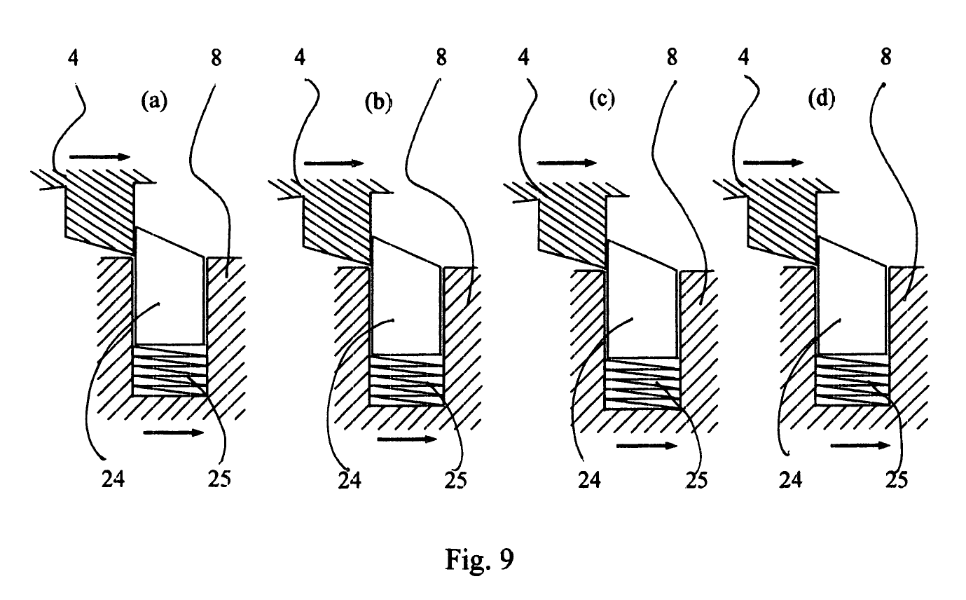

FIG. 7 explains how the torque gets transmitted from the gearwheel (10) to the wheel (8) and how the disengagement takes place between the gear wheel (10) and the wheel (21). Arrows in the figure show the directions of the swing. The spring-piston clutch mechanism (20) is explained by expanding one spring-piston unit of the part (20). The expanded configuration is shown in FIG. 8 and FIG. 9. In FIG. 8, the disengaging process is shown. FIG. 8(a) is the beginning of contact between the gear wheel (19) and the piston (24). As the gear wheel (19) moves to the right (which is the case in FIG. 7), the piston (24) moves downward and presses down the spring (25) [FIG. 8(b)]. FIG. 8(c) shows the end of the disengagement process. It is shown here that the spring (25) is pressed all the way down and the piston (24) is also moved all the way down. The next moment the gear wheel (19) passes the piston (24) tip and the piston (24) comes back to the original position and so is the spring (25). The gear wheel (19) moves to the right, but the wheel (21) does not follow the gear wheel (19).

FIG. 9 shows that as the gear wheel (4) moves to the right, the wheel (8) follows the gear wheel (4) because the piston (24) does not get pressed down and wheel (4) pushes the piston (24) and the wheel (8) at the same time to the right. Thus, the torque force gets transmitted from the gear wheel (10) to the wheel (8). In this set up, the wheel (8) swings in clockwise.

FIG. 10 shows a sketch of the Ocean Wave Electricity Generation system infrastructure. The cell box (26) contains the electricity generation cell (27). The cell box (26) is a waterproof container and it keeps the electricity generation cell (27) from contacting with the salty water. Thus, it prevents corrosion of the electricity generation cell (27). In this figure, only a part of one column of the Ocean Wave Electricity Generation system is shown. Many more columns can be added (28) to increase the amount of energy being collected. To collect the electricity, wires (29) are connected to the electrical output of every cell box (26). The ocean wave length (30) is shown here to compare with the bottom length of the cell box (26). The length of the bottom of the cell box is less than the quarter of ocean wave length but long enough to contain at least one electricity generation cell. The electricity generation cell (27) is oriented to attain maximum torque from the ocean waves and fixed within the cell box (26) such a way that the maximum torque can be generated by the mass (1). In FIG. 10, only 4 cell boxes are shown. Many more cells can be added (31, 41) to increase the amount of energy collection. The anchor cables (33) are installed where they are needed to hold the cell boxes. The cables are grounded (32) to keep the cell boxes where they were placed. To control the buoyancy of each cell, weight control device (34) is attached to the bottom of each cell box. In order to keep the distance between the cell boxes, extensions (35) are attached to the each cell box to avoid contacts between the cell boxes, and flexible hinges (36) are installed to allow each cell box swing freely. The distance between the flexible hinges (37) is approximately equal to the quarter length of the ocean wave, which should maximize the swing span of the mass (1). The bottom length (38) of the cell box (26) is long enough to accommodate at least one electricity generation cell (27) but short enough to avoid contacts between the cell boxes. All cell boxes are to be floating and some distance from the ocean ground (39) must be maintained. Part of the cell boxes are submerged in the ocean water (40) in FIG. 10. But they can be submerged completely so that their present may not impact the ocean scenery. Finally all the collected electrical energy gets transmitted to the ground (42).

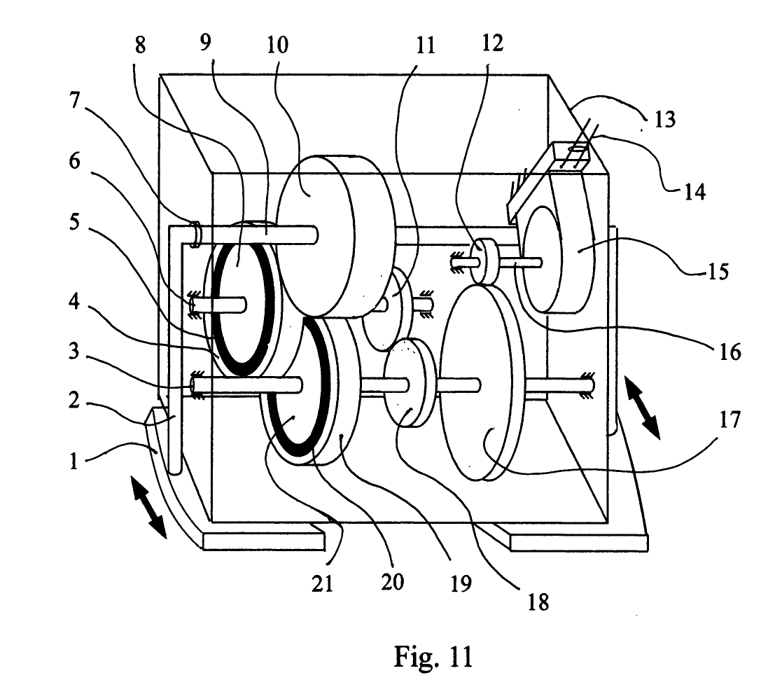

FIG. 11 shows one of many possible orientations of the electricity generation cell (27).

I claim:

1. A system that generates electricity from the ocean wave (or tide) by use of mechanical subsystems, submerged or on surface, collecting energy day and night regardless of any weather condition in a way similar to the way of collecting energy by use of solar panels or wind mills, without contacting the salty ocean water is comprising:
(A) electricity generation cells, cell boxes that accommodate the electricity generation cells, and infrastructure that provides inner connections of numerous cell boxes such that the electrical energy can be collected in massive manner;
(B) an electricity generation cell of claim 1-(A) wherein gear wheels, spring-piston clutch banks, heavy weight mass, and electricity generator that are properly designed and organized such that swing motion transforms into unidirectional rotation so that it can rotate the rotor of electricity generator to generate electricity;
(C) as a heavy mass (1) in FIG. 1 swings back and forth, the swing motion sways the gear wheel (10) in clockwise or counterclockwise, and if the gear wheel (10) swings in clockwise (FIG. 2), then the gear wheel (4) and the gear wheel (19) swing in counterclockwise, and by having the spring-piston clutching mechanism (5) disengage the gear wheel (4) from the wheel (8) while the spring-piston clutching mechanism (20) engage the gear wheel (19) and the wheel (21), the wheel (21) swings in counterclockwise while the wheel (8), in clockwise, and the counterclockwise swing of the wheel (21) causes the clockwise swing of the gear wheel (12); while when the gear wheel (10) swings in counterclockwise (FIG. 3), the gear wheel (4) and the gear wheel (19) swing in clockwise, and by having the spring-piston clutching mechanism (5) engage the gear wheel (4) and the wheel (8) while the spring-piston clutching mechanism (20) disengage the gear wheel (19) from the wheel (21), the wheel (8) swings in clockwise while the wheel (21), in counterclockwise, and the clockwise swing of the wheel (8) causes the counterclockwise swing of the gear wheel (18) and the gear wheel (17), which in turn causes the clockwise swing of the gear wheel (12), thus the back and force swing motion of the mass (1) transforms into unidirectional rotation, that is clockwise rotation, which rotates the rotor of electricity generator and generates electricity, noting that spring-piston clutching mechanisms are designed such that the wheels (8, 21, 18, 11, and 17) act like flywheels and store the torque energy; summarizing the claim above, a structure of the electricity generation cell of claim 1-(B) wherein as a heavy mass swings back and forth, it generates torque that swings gear wheel in clockwise or counterclockwise, transmitting the torque energy to two gear wheels that separate clockwise swing and counterclockwise swing via two sets of spring-piston clutching system, and by use of gear chain, either converting clockwise swing to counterclockwise swing or vise versa such that the back and forth motion of the mass (1) transforms into unidirectional rotation that rotates the rotor of electricity generator;
(D) a spring-piston clutch bank of claim 1-(B) wherein each spring-piston clutch unit has a spring and a piston that are configured such that the piston move downward as gear teeth of gear wheel travel in lateral direction contacting the piston, and move upward as the gear teeth of gear wheel passes the piston.

2. An infrastructure of the Ocean Wave Electricity Generation system is comprising:
(A) cell boxes (26), electricity generation cells (27), anchors (33), weight control subsystems (34), extensions (35), flexible hinges (36), and wires (29) that constitute the basic infrastructure of the total system;
(B) a cell box (26) of claim 2-(A) that is a water-proof container and that has an optimized bottom dimension to maximize the swing span of the cell box by having the length of the bottom is less than the quarter of the ocean wave length but long enough to accommodate at least one electricity generation cell (27);
(C) an electricity generation cells (27) of claim 2-(A) that is placed and fixed on the bottom of the cell box (26), optimally oriented for electricity generation cells (27) and the cell box (26) that offer maximum mass (1) swinging effect;
(D) anchors (33) of claim 2-(A) that ground the total system at a specific location in the ocean that support energy collection activity;
(E) a weight control subsystem (34) of claim 2-(A) that controls buoyancy and attitude of the cell box as well as increasing the mass swinging effect;
(F) an extension (35) of claim 2-(A) that is short enough to maximize the cell box bottom length but long enough to avoid the contacts between the cell boxes;
(G) a flexible hinge (36) of claim 2-(A) that allows individual cell box to swing as freely as possible;
(F) wires (29) of claim 2-(A) that are installed above the ocean surface and collect electricity from each electricity generation cell and transmits it to the ground;
(G) a large collection of the electricity generation cells are structured such that collection of electricity from each electricity generation cell, similar to solar cell system or windmill system, provides a large amount of electricity.
The present invention may be carried out in other specific ways than those herein set forth without departing from the spirit and essential characteristics of the invention. The present embodiments are, therefore, to be considered in all respects as illustrative and not restrictive, and all changes coming within the meaning and equivalency range of the appended claims are intended to be embraced therein.
